(19) United States
(12) Patent Application Publication
(10) Pub. No.: US 2012/0018338 A1
(43) Pub. Date: Jan. 26, 2012

(54) METHOD FOR AVOIDING GLASS FOGGING

(75) Inventors: Isabelle Bauer Dauphin, Kembs (FR); Hanns-Christian Mahler, Basel (CH)

(73) Assignee: Hoffman-La Roche Inc., Nutley, NJ (US)

(21) Appl. No.: 13/262,603

(22) PCT Filed: Mar. 26, 2010
(86) PCT No.: PCT/EP10/53974

§ 371 Date: Sep. 30, 2011

(30) Foreign Application Priority Data
Mar. 30, 2009 (EP) 09156582.0

(51) Int. Cl. B65D 85/00; F26B 5/06

(52) U.S. Cl. 206/524.1; 34/284

(57) ABSTRACT

The present invention relates to the use of a glass container having a contact angle of more than about 10° for preventing glass fogging during freeze drying of a pharmaceutical composition. The pharmaceutical composition comprises a therapeutic agent and a surfactant. The respective glass container and a method for freeze drying the pharmaceutical composition are also disclosed.

The present invention relates to the use of a glass container having a contact angle of more than 10° for preventing glass fogging during freeze drying of a pharmaceutical composition. The pharmaceutical composition comprises a therapeutic agent and a surfactant. The respective glass container and a method for freeze drying the pharmaceutical composition are also disclosed.

It is often undesirable to store pharmaceutical compositions in a liquid form due to potential stability problems. Some liquid formulations must be stored at low temperatures. Other deteriorate during storage in a liquid form. One possibility to overcome these issues is to freeze dry the pharmaceutical composition. It is transported and stored in a dry form which then has to be reconstituted before use.

However, the freeze drying process itself can result in a deterioration of the properties of the pharmaceutical composition, especially if the active agent is a protein. In order to avoid a reduction in the activity of the pharmaceutical composition lyoprotectants such as certain sugars as well as surfactants are commonly added to the pharmaceutical composition.

The present inventors have observed that in some cases a pharmaceutical composition, which contains a surfactant, can creep up the walls of a vial after it has been filled in. When such a pharmaceutical composition is freeze-dried, the pharmaceutical composition remains on the walls of the vial giving it a “fogged” appearance. Two such vials are shown in FIG. 1. The actual filling level can be clearly recognized. The “fogged” areas on the inner surface of the glass vial show that the pharmaceutical composition crept above this filling level and reached the shoulder of the vial. When the vial subsequently underwent a freeze-drying process, the pharmaceutical composition dried, leaving a white residue on the inner surface of the vial. Even if such a residue is only considered a cosmetic defect, it is still undesirable because it can impact the visual inspection of the vials and its bad appearance can be questioned by patients and doctors alike.

It is therefore an object of the present invention to provide a method for freeze drying a pharmaceutical composition in which glass fogging can be avoided.

In one aspect the present invention relates to a glass container comprising a pharmaceutical composition comprising:

(i) a therapeutic agent; and

(ii) a surfactant;

wherein the glass container has a contact angle of more than about 10°.

In a further aspect the present invention refers to a method for freeze drying a pharmaceutical composition, the method comprising the steps of:

(a) providing a glass container having a contact angle of more than about 10°;

(b) introducing a pharmaceutical composition comprising:

(i) a therapeutic agent; and

(ii) a surfactant;

into the glass container; and

(c) conducting freeze drying.

A method for preventing or reducing glass fogging is also provided which comprises the steps of:

(a) providing a glass container having a contact angle of more than about 10°;

(b) introducing a pharmaceutical composition comprising:

(i) a therapeutic agent; and

(ii) a surfactant;

into the glass container; and

(c) conducting freeze drying.

Yet another aspect of the invention is directed to the use of a glass container having a contact angle of more than about 10° for preventing or reducing glass fogging during freeze drying of a pharmaceutical composition comprising:

(i) a therapeutic agent; and

(ii) a surfactant.

### BRIEF DESCRIPTION OF THE FIGURES

FIG. 1: Photograph of two vials exhibiting glass fogging.

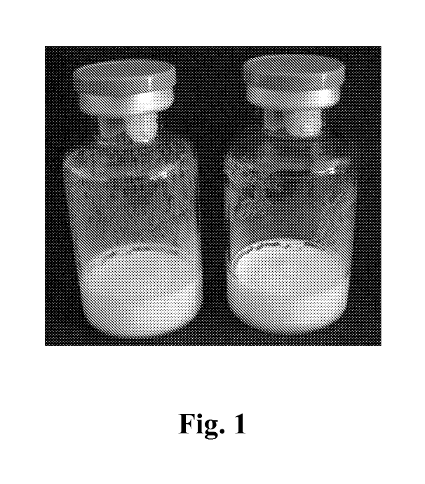

FIG. 2: Photograph of a liquid creeping up the walls of a glass vial. The first photograph was taken 20 s after the filling of the liquid had begun, the second photograph was taken after 32 s, and the third photograph was taken after 54 s.

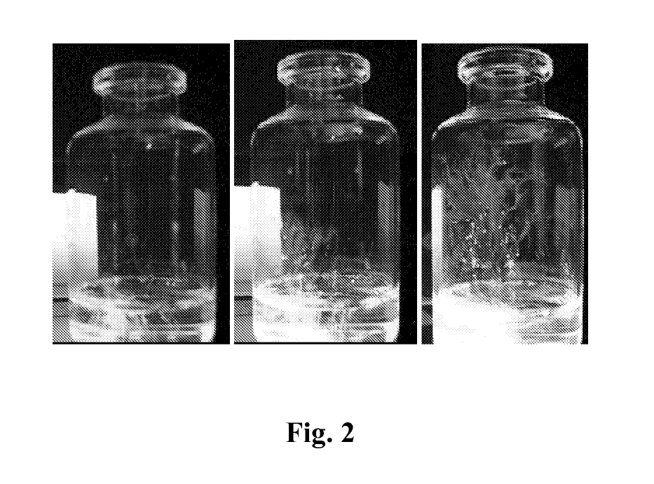

FIG. 3: Schematic representation of the contact angle.

FIG. 4: Vials of lot 070820G showing typical glass fogging up to the shoulder of the vials.

FIG. 5: Vial of lot 050530V not showing glass fogging.

FIG. 6: Vial of lot 7819 not showing glass fogging.

When a pharmaceutical composition comprising a therapeutic agent and a surfactant is filled into a glass container in a liquid form, the pharmaceutical composition can creep up the inner walls of the glass container, so that the pharmaceutical composition is present on the inner walls of the glass container at a height which is higher than the filling height of the pharmaceutical composition. Residue of the pharmaceutical composition can remain on the walls of the glass container at a height which is higher than the filling height, when the contents of the glass container are subsequently subjected to freeze drying. This effect is referred to as “glass fogging” in the present application. Although not wishing to be bound by theory, it is assumed that this effect might be caused by capillary forces.

In the present invention “filling height” refers to the height which the pharmaceutical composition would be expected to reach in the glass container based on its volume.

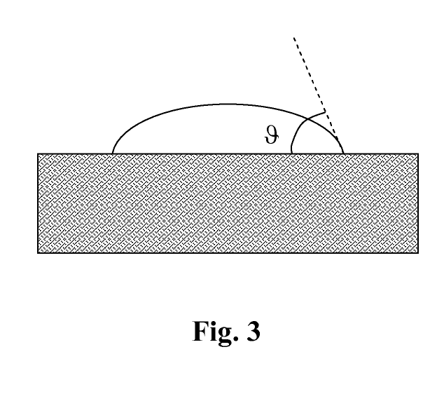

The present inventors have surprisingly found that glass fogging can be prevented or reduced if a glass container is employed which has a contact angle of more than about 10°, preferably at least about 15°, more preferably at least about 20°, most preferably at least about 25°. The contact angle is measured by DIN EN ISO/IEC 17025 using distilled water. The contact angle φ is defined as the angle at which a liquid/vapor interface meets a solid surface. The contact angle is illustrated schematically in FIG. 3.

The glass material of the container is not particularly limited as long as it has a contact angle of more than about 10°. Typically the glass will be Type I glass classified as hydrolytic resistance glass of Class HGB1 according to ISO 719. Desirably the glass will also have an acid resistance of Class S1 according to DIN12116. The alkali resistance is preferably either Class A2 or Class A1 according to ISO 695.

One type of glass that is suitable is borosilicate glass. It can comprise about 3 to about 8 weight-% alkali metal oxides such as sodium oxide (Na2O) and potassium oxide (K2O), about 1 to about 7 weight-% aluminium oxide (Al2O3), upto about 5 weight-% alkaline metal earth oxides, about 70 to about 85 weight-% silica (SiO2), and about 7 to about 15 weight-% boron oxide (B2O3). The glass will typically have a coefficient of mean linear thermal expansion (α (20° C., 300° C.) according to ISO 7991 in the range of about 3 to about 6·10⁻⁶ K⁻¹. The glass transition temperature Tg is preferably in the range of about 510 to about 600° C. The density of the glass will usually be in the range of about 2.1 to about 2.4 g/cm³ at 25° C.

Borosilicate glass is commercially available under the trade designations Duran®, Pyrex®, Ilmabor®, Simax®, Fiolax® and BORO-8330™. Preferably Fiolax®, BORO-8330™ and Duran® glass are employed.

The surface of the glass can optionally be modified. For example, it is possible to employ siliconized borosilicate glass which is available from various suppliers. Any other methods of surface modification which result in a surface having a contact angle of more than about 10° such as physical treatments (e.g., tempering) or chemical treatments (e.g. fluoro- or silane-based coatings) are also possible.

Because the glass container is to contain a pharmaceutical composition, it must conform to the usual medical standards. Therefore, it has to be washed and depyrogenized according to the prescribed methods before the pharmaceutical composition is filled in. Such methods include the EU and US Good Manufacturing Practice.

The present inventors have determined that the contact angle of the glass container can be influenced by several parameters such as the composition of the glass, the method by which the glass is formed into a container, the washing and depyrogenation methods as well as the coating. It is possible that the contact angle of two containers will be different, even if the composition of the glass is the same for instance if the glass container is subjected to different forming treatments or different depyrogenation procedures. Therefore, the susceptibility to glass fogging must be assessed on the basis of washed and depyrogenized glass container in the state in which it is filled with the pharmaceutical composition.

The pharmaceutical composition comprises at least one therapeutic agent and at least one surfactant.

Any therapeutic agent which can be freeze-dried can be employed in the present invention. Typically, the therapeutic agent will comprise a protein, a peptide and/or a nucleic acid, but the present invention is not restricted thereto.

Within the meaning of the present invention, a “protein” is any sequence of amino acids which exhibits a tertiary and/or quaternary structure. Typically, the protein will have a molecular weight of at least about 5 kD, preferably at least about 50 kD. Proteins not only include single chain proteins but also complexes and linked proteins and peptides like the linked heavy and light chains of antibodies. Examples of proteins include lipoproteins, enzymes (including activators and inhibitors), hormones, receptors, ligands, antibodies (including monoclonal and polyclonal antibodies, multispecific (e.g. bispecific) antibodies, fusion proteins of antibodies, antibody fragments or other proteins either produced by covalent modification or co-expression, as known in the art), cytokines, lymphokines, regulatory proteins, vaccines, signalling molecules, chaperones, and biologically active fragments or variants of the above.

The preferred protein is an antibody, particularly a monoclonal antibody. The term “antibody” is used in the broadest sense in the present invention and covers monoclonal antibodies, polyclonal antibodies, diabodies, humanized antibodies, CDR-grafted antibodies, single-chain antibodies, multispecific antibodies such as bispecific-hybride antibodies, fully human antibodies, as well as antibody fragments such as Fab fragments, individual CDR regions and the like.

The term “antibody/antibodies” is used herein synonymously with the term “antibody molecule(s)” and comprises, in the context of the present invention, antibody molecule(s) like full immunoglobulin molecules, e.g. IgMs, IgDs, IgEs, IgAs or IgGs, like IgGl, IgG2, IgG2b, IgG3 or IgG4 as well as parts of such immunoglobulin molecules, like Fab-fragments, Fab′-fragments, F(ab)₂-fragments, chimeric F(ab)₂ or chimeric Fab′ fragments, chimeric Fab-fragments or isolated VH- or CDR-regions (said isolated VH- or CDR-regions being, e.g., to be integrated or engineered in corresponding “framework(s)”) Accordingly, the term “antibody” also comprises known isoforms and modifications of immunoglobulins, like single-chain antibodies or single chain Fv fragments (scAB/scFv) or bispecific antibody constructs. A specific example of such an isoform or modification may be a sc (single chain) antibody in the format VH-VL or VL-VH5. Also bispecific scFvs are envisaged, e.g. in the format VH-VL-VH-VL, VL-VH-VH-VL, VH-VL-VL-VH. Also comprised in the term “antibody” are diabodies and molecules that comprise an antibody Fc domain as a vehicle attached to at least one antigen binding moiety/peptide, e.g. peptibodies as described in WO 00/24782. It is evident that mixtures of antibodies/antibody molecules can also be employed.

“Antibody fragments” also comprises such fragments which per se are not able to provide effector functions (ADCC/CDC) but provide this function in a manner according to the invention after being combined with appropriate antibody constant domain(s). The antibody(ies) that may be comprised in the pharmaceutical composition can be recombinantly produced antibody(ies). These may be produced in a mammalian cell-culture system, e.g. in CHO cells. The antibody molecules may be further purified by a sequence of chromatographic and filtration steps.

The term “monoclonal antibody” as used herein refers to a preparation of antibody molecules of a single amino acid composition. Accordingly, the term “human monoclonal antibody” refers to antibodies displaying a single binding specificity which have variable and constant regions derived from human germline immunoglobulin sequences. In one embodiment, the human monoclonal antibodies are produced by a hybridoma which includes a B cell obtained from a transgenic non-human animal, e.g. a transgenic mouse, having a genome comprising a human heavy chain transgene and a light human chain transgene fused to an immortalized cell.

The term “chimeric antibody” refers to a monoclonal antibody comprising a variable region, i.e., binding region, from one source or species and at least a portion of a constant region derived from a different source or species, usually prepared by recombinant DNA techniques. Chimeric antibodies comprising a murine variable region and a human constant region are especially preferred. Such murine/human chimeric antibodies are the product of expressed immunoglobulin genes comprising DNA segments encoding murine immunoglobulin variable regions and DNA segments encoding human immunoglobulin constant regions. Other forms of “chimeric antibodies” encompassed by the present invention are those in which the class or subclass has been modified or changed from that of the original antibody. Such “chimeric” antibodies are also referred to as “class-switched antibodies”. Methods for producing chimeric antibodies involve conventional recombinant DNA and gene transfection techniques now well known in the art, e.g., Morrison, S. L. et al., Proc. Natl. Acad Sci. USA 81 (1984) 6851-6855; U.S. Pat. Nos. 5,202,238 and 5,204,244.

The term “humanized antibody” refers to antibodies in which the framework or “complementarity determining regions” (CDR) have been modified to comprise the CDR of an immunoglobulin of different specificity as compared to that of the parent immunoglobulin. In a preferred embodiment, a murine CDR is grafted into the framework region of a human antibody to prepare the “humanized antibody” (e.g., Riechmann, L. et al., Nature 332 (1988) 323-327; and Neuberger, M. S. et al., Nature 314 (1985) 268-270). Particularly preferred CDRs correspond to those representing sequences recognizing the antigens noted above for chimeric and bifunctional antibodies.

The term “human antibody”, as used herein, is intended to include antibodies having variable and constant regions derived from human germline immunoglobulin sequences.

The term “recombinant human antibody”, as used herein, is intended to include all human antibodies that are prepared, expressed, created or isolated by recombinant means, such as antibodies isolated from a host cell such as an SP2-0, NSO or CHO cell (like CHO Kl) or from an animal (e.g. a mouse) that is transgenic for human immunoglobulin genes or antibodies expressed using a recombinant expression vector transfected into a host cell. Such recombinant human antibodies have variable and constant regions derived from human germline immunoglobulin sequences in a rearranged form. The recombinant human antibodies can be subjected to in vivo somatic hypermutation. Thus, the amino acid sequences of the VH and VL regions of the recombinant antibodies are sequences that, while derived from and related to human germline VH and VL sequences, may not naturally exist within the human antibody germline repertoire in vivo.

In various aspects, the antibody is selected from the group consisting of Humira (adalimumab), Synagis (palivizumab), AMG 714 (anti-IL15 antibody), vectibix (panitumumab), Rituxan (rituximab), zevalin (ibritumomab tiuxetan), anti-CD80 monoclonal antibody (mAb) (galiximab), anti- CD23 mAb (lumiliximab), M200 (volociximab), anti-Cripto mAb, anti-BR3 mAb, anti-IGFIR mAb, Tysabri (natalizumab), Daclizumab, humanized anti-CD20 mAb (ocrelizumab), soluble BAFF antagonist (BR3-Fc), anti-CD40L mAb, anti-TWEAK mAb, anti-IL5 Receptor mAb, anti-ganglioside GM2 mAb, anti-FGF8 mAb, anti-VEGFR/Flt-1 mAb, anti-ganglioside GD2 mAb, Actilyse(R) (alteplase), Metalyse(R) (tenecteplase), CAT-3888 and CAT-8015 (anti-CD22 dsFv-PE38 conjugates), CAT-354 (anti-IL13 mAb), CAT-5001 (anti-mesothelin dsFv-PE38 conjugate), GC-1008 (anti-TGF-[beta] mAb), CAM-3001 (anti-GM-CSF Receptor mAb), ABT-874 (anti-IL12 mAb), Lymphostat B (Belimumab; anti-BlyS mAb), HGS-ETR1 (mapatumumab; human anti-TRAIL Receptor-1 mAb), HGS-ETR2 (human anti-TRAIL Receptor-2 mAb), ABthrax™ (human, anti-protective antigen (from B. anthracis) mAb), MYO-029 (human anti-GDF-8 mAb), CAT-213 (anti-eotaxinl mAb), Erbitux (Cetuximab), Epratuzumab, Remicade (infliximab; anti-TNF mAb), Herceptin (traztusumab), Mylotarg (gemtuzumab ozogamicin), VECTIBIX (panatumamab), ReoPro (abciximab), Actemra (anti-IL6 Receptor mAb), HuMax-CD4 (zanolimumab), HuMax-CD20 (ofatumumab), HuMax-EGFr (zalutumumab), HuMax-Inflam, R 1507 (anti-IGF-1R mAb), HuMax HepC, HuMax CD38, HuMax-TAC (anti-IL2Ra or anti- CD25 mAb), HuMax-ZP3 (anti-ZP3 mAb), Bexxar (tositumomab), Orthoclone OKT3 (muromonab-CD3), MDX-010 (ipilimumab), anti-CTLA4, CNTO 148 (golimumab; anti-TNF[alpha] Inflammation mAb), CNTO 1275 (anti-IL12/IL23 mAb), HuMax-CD4 (zanolimumab), HuMax-CD20 (ofatumumab), HuMax-EGFR (zalutumumab), MDX-066 (CDA-I) and MDX-1388 (anti-C difficile Toxin A and Toxin B C mAbs), MDX-060 (anti-CD30 mAb), MDX-018, CNTO 95 (anti-integrin receptors mAb), MDX-1307 (anti-Mannose Receptor/hCG[beta] mAb), MDX-1100 (anti-IPIO Ulcerative Colitis mAb), MDX-1303 (Valortim™), anti-B. anthracis Anthrax, MEDI-545 (MDX-1103, anti-IFN[alpha]), MDX-1106 (ONO-4538; anti-PD1), NVS Antibody #1, NVS Antibody #2, FG-3019 (anti-CTGF Idiopathic Pulmonary Fibrosis Phase I Fibrogen), LLY Antibody, BMS-66513, NI-0401 (anti-CD3 mAb), IMC-18F1 (VEGFR-I), IMC-3G3 (anti-PDGFR[alpha]), MDX-1401 (anti-CD30), MDX-1333 (anti-IFNAR), Synagis (palivizumab; anti-RSV mAb), Campath (alemtuzumab), Velcade (bortezomib), MLN0002 (anti- alpha4beta7 mAb), MLN 1202 (anti-CCR2 chemokine receptor mAb)., Simulect (basiliximab), prexige (lumiracoxib), Xolair (omalizumab), ETI211 (anti-MRSA mAb), Zenapax (Daclizumab), Avastin (Bevacizumab), MabTheraRA (Rituximab), Zevalin (ibritumomab tiuxetan), Zetia (ezetimibe), Zyttorin (ezetimibe and simvastatin), NI-0401 (human anti-CD3), Adecatumumab, Golimumab (anti-TNF[alpha] mAb), Epratuzumab, gemtuzumab, Raptiva (efalizumab), Cimzia (certolizumab pegol, CDP 870), (Soliris) Eculizumab, Pexelizumab (Anti-CS Complement), MEDI-524 (Numax), Lucentis (Ranibizumab), 17-IA (Panorex), Trabio (lerdelimumab), TheraCim hR3 (Nimotuzumab), Omnitarg (Pertuzumab), Osidem (IDM-I), OvaRex (B43.13), Nuvion (visilizumab), anti-CD4OL mAb (IDEC-131), Xanelim(humanized anti-CD 1 Ia) and Cantuzamab.

The concentration of the therapeutic agent in the pharmaceutical composition will depend on the therapeutic agent and its intended use. Typically, the concentration will be in the range of about 0.01 to about 200 mg/ml, preferably in the range of about 1 to about 200 mg/ml.

The pharmaceutical composition also includes a surfactant. The term “surfactant”, as used herein, denotes a pharmaceutically acceptable excipient which is used to protect protein formulations against mechanical stresses like agitation and shearing. The surfactant can be anionic, nonionic or cationic. Preferably non-ionic surfactants are employed in the present invention because these are especially likely to result in glass fogging. Examples of pharmaceutically acceptable surfactants include polyoxyethylene sorbitan fatty acid esters (Tween, Polysorbate), polyoxyethylene alkyl ethers (Brij), alkylphenylpolyoxyethylene ethers (Triton-X), polyoxyethylene-polyoxypropylene copolymer (Poloxamer, Pluronic), and sodium dodecyl sulfate (SDS). Surfactants which are most likely to cause glass fogging are polyoxyethylene sorbitan fatty acid esters. Preferred examples have 10 to 30 polyoxyethylene groups. The fatty acids preferably have 10 to 22 carbon atoms. Examples include Polysorbate 20 (polyoxyethylene (20) sorbitan monolaurate sold under the trademark Tween 20™) and Polysorbate 80 (polyoxyethylene (20) sorbitan monooleate sold under the trademark Tween 80™). Preferred polyethylene-polypropylene copolymers are those sold under the names Pluronic® F68 or Poloxamer 188™. Preferred polyoxyethylene alkyl ethers are those sold under the trademark Brij™. Preferred alkylphenolpolyoxyethylene esters are sold under the tradename Triton-X. The surfactant is generally used in a concentration range of about 0.001 to about 1%, preferably of about 0.005 to about 0.1% and more preferably about 0.01% to about 0.04% (weight/volume).

The pharmaceutical composition can also contain any other pharmaceutically acceptable components in addition to the therapeutic agent and the surfactant. Examples include buffers, carriers, excipients, solvents and co-solvents, antioxidants, chelators, stabilizers, tonicity agents, preservatives, wetting agents, emulsifying agents, dispersing agents and the like. These components are described, e.g., in Remington's Pharmaceutical Sciences, 17th edition.

The pharmaceutical composition will be provided in the glass container in a liquid form, typically in the form of an aqueous solution.

Depending on the nature of the therapeutic agent it might be necessary to adjust the pH of the pharmaceutical composition to a range in which the therapeutic agent is stable. Proteins, for example, are often stable in a narrow pH range, so that the pH should be adapted accordingly in order to avoid physical and/or chemical degradation. If desired, a buffering agent may be employed. The term “buffer” as used herein denotes a pharmaceutically acceptable excipient, which stabilizes the pH of a pharmaceutical preparation. Suitable buffers are well known in the art and are described in the literature. Preferred pharmaceutically acceptable buffers comprise, but are not limited to, histidine buffers, citrate buffers, succinate buffers, acetate buffers and phosphate buffers. More preferred buffers comprise L-histidine or mixtures of L-histidine and L-histidine hydrochloride with pH adjustment with an acid or a base known in the art. If present, the above-mentioned buffers are generally used in an amount of about 1 mM to about 100 mM, preferably of about 5 mM to about 50 mM and more preferably of about 10 to about 20 mM. Independently from the buffer used, the pH can be adjusted to a value from about 4.0 to about 7.0 and preferably about 5.0 to about 6.5 and more preferably about 5.5 to about 6.0 with an acid or a base known in the art, e.g. hydrochloric acid, acetic acid, phosphoric acid, sulfuric acid, citric acid, sodium hydroxide and potassium hydroxide.

A range of compounds can be used as stabilizers. The term “stabilizer” denotes a pharmaceutically acceptable excipient, which protects the therapeutic agent and/or the formulation from chemical and/or physical degradation during manufacturing, storage and application. Chemical and physical degradation pathways of pharmaceuticals have been reviewed by Cleland et al. (1993), Crit. Rev. Ther. Drug Carrier Syst. 10(4):307-77, Wang (1999) Int. J. Pharm. 185(2):129-88, Wang (2000) Int. J. Pharm. 203(1-2):1-60 and Chi et al. (2003) Pharm. Res. 20(9):1325-36. Stabilizers include, but are not limited to, sugars, amino acids, polyols, cyclo dextrines, e.g. hydroxypropyl-β-cyclodextrine, sulfobutylethyl-β-cyclodextrin, β-cyclodextrin, polyethylene glycols, e.g. PEG 3000, PEG 3350, PEG 4000, PEG 6000, albumine, human serum albumin (HSA), bovine serum albumin (BSA), salts, e.g. sodium chloride, magnesium chloride, calcium chloride, and chelators, e.g. EDTA. Stabilizers can be present in the formulation in an amount of about 1 to about 500 mM, preferably in an amount of about 10 to about 300 mM and more preferably in an amount of about 100 mM to about 300 mM.

The term “sugar” as used herein denotes a monosaccharide or an oligosaccharide. A monosaccharide is a monomeric carbohydrate which is not hydrolyzable by acids, including simple sugars and their derivatives, e.g. aminosugars. Examples of monosaccharides include glucose, fructose, galactose, mannose, sorbose, ribose, deoxyribose and neuraminic acid. An oligosaccharide is a carbohydrate consisting of more than one monomeric saccharide unit connected via glycosidic bond(s) either branched or in a chain. The monomeric saccharide units within an oligosaccharide can be identical or different. Depending on the number of monomeric saccharide units the oligosaccharide is a di-, tri-, tetra-, penta- and so forth saccharide. In contrast to polysaccharides the monosaccharides and oligosaccharides are water soluble. Examples of oligosaccharides include sucrose, trehalose, lactose, maltose and raffinose. Preferred sugars are sucrose and trehalose, most preferred is trehalose.

The term “amino acid” as used herein denotes a pharmaceutically acceptable organic molecule possessing an amino moiety located at an a-position to a carboxylic group. Examples of amino acids include arginine, glycine, ornithine, lysine, histidine, glutamic acid, asparagic acid, isoleucine, leucine, alanine, phenylalanine, tyrosine, tryptophane, methionine, serine and proline. Amino acids are generally used in an amount of about 10 to about 500 mM, preferably in an amount of about 10 to about 300 mM and more preferably in an amount of about 100 to about 300 mM.

The term “polyols” as used herein denotes pharmaceutically acceptable alcohols with more than one hydroxy group. Suitable polyols comprise, but are not limited to, mannitol, sorbitol, glycerine, dextran, glycerol, arabitol, propylene glycol, polyethylene glycol, and combinations thereof. Polyols can be used in an amount of about 10 mM to about 500 mM, preferably in an amount of about 10 to about 300 mM and more preferably in an amount of about 100 to about 300 mM.

A subgroup within the stabilizers are lyoprotectants. The term “lyoprotectant” denotes pharmaceutically acceptable excipients, which protect a labile active ingredient (e.g., a protein) against destabilizing conditions during the freeze drying process, subsequent storage and reconstitution. Lyoprotectants comprise, but are not limited to, the group consisting of sugars, polyols (e.g. sugar alcohols) and amino acids. Preferred lyoprotectants can be selected from the group consisting of sugars (such as sucrose, trehalose, lactose, glucose, mannose, maltose, galactose, fructose, sorbose, raffinose, and neuraminic acid), amino sugars (such as glucosamine, galactosamine, and N-methylglucosamine (“Meglumine”)), polyols (such as mannitol and sorbitol), and amino acids (such as arginine and glycine). Lyoprotectants are generally used in an amount of about 10 to about 500 mM, preferably in an amount of about 10 to about 300 mM and more preferably in an amount of about 100 to about 300 mM.

A subgroup within the stabilizers are antioxidants. The term “antioxidant” denotes pharmaceutically acceptable excipients, which prevent oxidation of the active pharmaceutical ingredient. Antioxidants comprise, but are not limited to, ascorbic acid, glutadione, cysteine, methionine, citric acid, and EDTA. Antioxidants can be used in an amount of about 1 to about 100 mM, preferably in an amount of about 5 to about 50 mM and more preferably in an amount of about 5 to about 20 mM.

The term “tonicity agents” as used herein denotes pharmaceutically acceptable tonicity agents. Tonicity agents are used to modulate the tonicity of the formulation. Isotonicity in general relates to the osmostic pressure relative to a comparative solution. The formulation according to the invention can be hypotonic, isotonic or hypertonic but will preferably be isotonic. An isotonic formulation is liquid or liquid reconstituted from a solid form, e.g. from a freeze-dried form and denotes a solution having the same tonicity as some other solution with which it is compared, such as physiological salt solution or blood serum. Suitable tonicity agents comprise, but are not limited to, sodium chloride, potassium chloride, glycerine and any component from the group of amino acids, or sugars. Tonicity agents are generally used in an amount of about 5 mM to about 500 mM. In a preferred pharmaceutical composition, the amount of tonicity agent is in the range of about 50 mM to about 300 mM.

Within the stabilizers and tonicity agents there is a group of compounds which can function in both ways, i.e. they can at the same time be a stabilizer and a tonicity agent. Examples thereof can be found in the group of sugars, amino acids, polyols, cyclodextrines, polyethylene glycols and salts. An example of a sugar which can at the same time be a stabilizer and a tonicity agent is trehalose.

The compositions may also contain adjuvants such as preservatives, wetting agents, emulsifying agents and dispersing agents. Prevention of presence of microorganisms may be ensured both by sterilization procedures and by the inclusion of various antibacterial and antifungal agents, for example, paraben, chlorobutanol, phenol, sorbic acid, and the like.

Preservatives are generally used in an amount of about 0.001 to about 2% (w/v). Preservatives comprise, but are not limited to, ethanol, benzyl alcohol, phenol, m-cresol, p-chlor-m-cresol, methyl or propyl parabens, and benzalkonium chloride.

A preferred pharmaceutical composition comprises:

about 0.01 to about 200 mg/ml of a protein;

0 to about 100 mM of a buffer;

about 0.001 to about 1% of a surfactant; and

about 1 to about 500 mM of a stabilizer and/or about 5 to about 500 mM of a tonicity agent.

In a further preferred embodiment the pharmaceutical composition comprises:

about 1 to about 200 mg/ml of an antibody;

0 to about 100 mM of a buffer;

about 0.001 to about 1% of a surfactant; and

about 1 to about 500 mM of a stabilizer and/or about 5 to about 500 mM of a tonicity agent.

The pH of these formulations is preferably about 4.0 to about 7.0.

For clarity reasons, it is emphasized that the concentrations as indicated herein relate to the concentration in a liquid which is filled into the glass container before freeze drying.

Accordingly, the freeze-dried formulations can be reconstituted from a lyophilisate in such a way that the resulting reconstituted formula comprises the respective constituents in the concentrations described herein. However, it is evident for a skilled person that the lyophilisates may also be reconstituted using such an amount of reconstitution medium that the resulting reconstituted formulation is either more concentrated or less concentrated.

The term “liquid” as used herein in connection with the pharmaceutical composition denotes a composition which is liquid at a temperature of at least about 2 to about 8° C. under atmospheric pressure.

The term “lyophilisate” as used herein in connection with the pharmaceutical composition denotes a composition which is manufactured by freeze-drying methods known in the art per se. The solvent (e.g., water) is removed by freezing, followed by sublimation under vacuum and desorption of residual water at elevated temperature. The lyophilisate usually has a residual moisture content of about 0.1 to about 5% (w/w) and is present as a powder or a physically stable cake. The lyophilisate is characterized by a fast dissolution after addition of a reconstitution medium.

The term “reconstituted formulation” as used herein in connection with the pharmaceutical composition denotes a composition which is freeze-dried and re-dissolved by addition of reconstitution medium. The reconstitution medium can comprise, but is not limited to, water for injection (WFI), bacteriostatic water for injection (BWFI), sodium chloride solutions (e.g. about 0.9% (w/v) NaCl), glucose solutions (e.g. about 5% glucose), surfactant, containing solutions (e.g. about 0.01% Polysorbate 20), and a pH-buffered solution (e.g. phosphate-buffered solutions).

The freeze drying is carried out by filling the above described liquid pharmaceutical composition into the glass container and conducting freeze drying according to conventional techniques well-known in the art. Freeze drying is usually conducted in three steps: freezing, primary drying and secondary drying.

During the freezing step the liquid pharmaceutical composition is cooled to a temperature which is usually below its eutectic point. The temperature during this step will typically be about −10° C. to about −80° C., preferably about −20° C. to about −60° C. Atmospheric pressure is typically employed during this step.

In the primary drying step the temperature is generally increased and the pressure is reduced in order to sublimate the solvent. The temperature is preferably about −40° C. to about +50° C., preferably about −30° C. to about +40° C. The pressure is about 3 Pa to about 80 Pa, preferably about 5 Pa to about 60 Pa. The primary drying step is usually conducted until at least about 90% of the solvent has been removed.

During the secondary drying step more solvent is removed by further increasing the temperature, e.g. to about 10° C. to about 50° C., preferably about 20° C. to about 40° C. The pressure is about 3 Pa to about 40 Pa, preferably about 5 Pa to about 30 Pa. When the secondary drying step is completed, the water content of the lyophilisate is usually at most about 5%.

Optionally, the freezing step can be preceded by a pre-cooling step, in which the temperature is lowered to about 2° C. to about 10° C.

Due to the hydrophobic nature of the walls of the glass container, glass fogging can be prevented or significantly reduced compared to freeze drying using conventional glass vials having a contact angle of less than about 10°. Therefore, the present invention provides an easy and convenient route for the preparation of a freeze-dried pharmaceutical composition which has a highly acceptable appearance for patients and doctors alike.

The invention will be illustrated by the following examples, which, however, should not be construed as limiting. Unless indicated otherwise throughout the specification all percentages are weight percentages.

### EXAMPLES

A pharmaceutical composition containing approx. 25 mg/ml of an anti-IGF-1R human monoclonal antibody, 20 mM L-histidine, 250 mM trehalose, and 0.01% Polysorbate 20 at pH 5.5 was sterile filtered through 0.22 μm filters and aseptically filled into glass vials. The vials were then partly closed with ETFE (copolymer of ethylene and tetrafluoroethylene)-coated rubber stoppers and freeze-dried using the freeze-drying cycle reported in Table 1.

(The term “anti-IGF-1R human monoclonal antibody” or “huMAb IGF-IR” includes an antibody as described in WO2005/005635).

TABLE 1

| | Shelf | | | Vacuum |
|---|---|---|---|---|
| | temperature | Ramp Rate | Hold time | Set point |
| Step | (° C.) | (° C./min) | (min) | (μbar) |
| Pre-cooling | 5° C. | 0.0 | 60 | — |
| Freezing | −40° C. | 1.0 | 120 | — |
| Primary Drying | −25° C. | 0.5 | approx. 4560 | 80 |
| Secondary Drying | +25° C. | 0.2 | 300 | 80 |

The pharmaceutical composition was first cooled from room temperature to approx. 5° C. (pre-cooling), followed by a freezing step at −40° C. with a plate cooling rate of approx. 1° C./min, followed by a holding step at −40° C. for about 2 hours. The first drying step was performed at a plate temperature of approx. −25° C. and a chamber pressure of approx. 80 μbar for about 76 hours. Subsequently, the second drying step started with a temperature ramp of 0.2° C./min from −25° C. to 25° C., followed by a holding step at 25° C. for at least 5 hours at a chamber pressure of approx. 80 μbar.

Freeze drying was carried out in a LyoStar II Freeze-dryer (FTS Systems, Stone Ridge, N.Y., USA) or Usifroid SMH-200 freeze-dryer (Usifroid, Maurepas, France). The freeze-dried vials were then visually inspected for glass fogging.

The following vials were employed in the present examples.

TABLE 2

| | | | Man- | Pre- |
|---|---|---|---|---|
| Vial Lot No. | Glass quality | Coating | ufacturer | treatment* |
| 070820G | Fiolax | none | Schott | no |
| | (exp. coef. 5.1) | | | |
| 050530V | Duran | none | Ompi | no |
| | (exp. coef. 3.3) | | | |
| 7819 | Type I plus | hydrophobic | Schott | no |
| | hydrophobic** | coating | | |
| 071001V | Duran | none | Ompi | no |
| | (exp. coef. 3.3) | | | |
| 080229G | Fiolax | none | Schott | yes |
| | (exp. coef. 5.1) | | | |
| 050530V | Duran | none | Ompi | yes |
| | (exp. coef. 3.3) | | | |
| 6100599326 | Fiolax | hydrophobic | Schott | yes |
| | (exp. coef. 5.1)*** | coating | | |

*washing and depyrogenization
**siliconized, PICVD coating (PICVD = Plasma Impulsed Chemical Vapor Deposition). The surface properties of these vials are like baked silicone but it is a covalently bound layer.
***siliconized

The thermal expansion coefficient is given in 10⁻⁶K⁻¹.

### Example 1

### Study Performed in the LyoStar II Freeze-Dryer

For the study performed in the LyoStar II freeze-dryer, different lots of vials having different wetting properties as described by their contact angles were filled with the pharmaceutical composition. For each vial lot except lot 071001V, for which only 13 vials were available, 40 vials were filled, partly closed and freeze dried according to the above mentioned cycle. After freeze drying the vials were visually inspected for glass fogging.

TABLE 3

| | Contact angle H₂O (°) [±3°] | |
|---|---|---|
| | (measured between 1 and 3 cm | Results |
| Vial lot No. | above vial bottom) | (glass fogging/total) |
| 070820G | <10 | 40/40 |
| 050530V | ≧25 | 0/37* |
| 7819 | >80 | 0/40 |
| 071001V | ≧20 | 0/13 |

*3 vials were broken when the vials were fully closed in the freeze dryer

Glass fogging was found with all vials of Lot No. 070820G, whereas the vials of the other lots did not show glass fogging. As described by the low contact angle, vials of Lot No. 070820G had a high degree of wetting resulting in glass fogging.

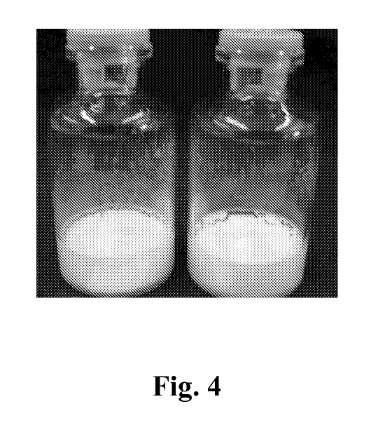

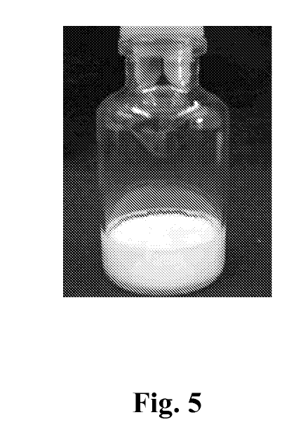

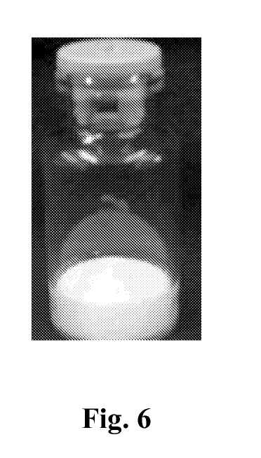

FIG. 4 shows vials of lot 070820G showing typical glass fogging up to the shoulder of the vials. A vial of lot 050530V and a vial of lot 7819 which do not exhibit glass fogging are shown in FIGS. 5 and 6, respectively.

### Example 2

### Study Performed in the Usifroid SMH-200 Freeze-Dryer

For the study performed in the Usifroid SMH-200 freeze-dryer, 3 different vial lots having different wetting properties as described by their contact angles (see Table 4) were washed in a Bosch RUR L02 vial washing machine and depyrogenated in a Bosch TSQ UO3 depyrogenation tunnel before being filled with the pharmaceutical composition. After filling, the 20 mL vials were partly closed with the stopper and freeze dried according to the above mentioned freeze drying cycle. After freeze drying the vials were visually inspected for glass fogging.

TABLE 4

| | Contact angle (°) [±3°] | |
|---|---|---|
| | (measured between 1 and 3 cm | Results |
| Vial Lot No. | above vial bottom) | (glass fogging/total) |
| 080229G | <10 | 343/343 |
| 050530V | ≧25 | 0/331 |
| 6100599326 | >80 | 0/314 |

Glass fogging was found with all vials of Lot No. 080229G, whereas the vials of the other lots did not show glass fogging. As described by the low contact angle, vials of Lot No. 080229G had a high degree of wetting resulting in glass fogging.

1. A glass container comprising a pharmaceutical composition comprising:
(i) a therapeutic agent; and
(ii) a surfactant;
wherein the glass container has a contact angle of more than about 10°.

2. The glass container according to claim 1, wherein the pharmaceutical composition is in the form of an aqueous composition.

3. The glass container according to claim 1, wherein the pharmaceutical composition is in a freeze-dried form.

4. The glass container according to any one of claims 1 to 3, wherein the therapeutic agent is a protein.

5. The glass container according to claim 4, wherein the therapeutic agent is an antibody.

6. The glass container according to claim 1, wherein the surfactant is a non-ionic surfactant.

7. The glass container according to claim 6, wherein the surfactant is a polyoxyethylene sorbitan fatty acid ester.

8. The glass container according to claim 1, wherein the pharmaceutical composition comprises:
about 0.01 to about 200 mg/ml of a protein;
0 to about 100 mM of a buffer;
about 0.001 to about 1% of a surfactant; and
about 1 to about 500 mM of a stabilizer and/or about 5 to about 500 mM of a tonicity agent.

9. The glass container according to claim 1, wherein the pharmaceutical composition comprises:
about 1 to about 200 mg/ml of an antibody;
0 to about 100 mM of a buffer;
about 0.001 to about 1% of a surfactant; and
about 1 to about 500 mM of a stabilizer and/or about 5 to about 500 mM of a tonicity agent.

10. A method for freeze drying a pharmaceutical composition, the method comprising the steps of:
(a) providing a glass container having a contact angle of more than about 10° ;
(b) introducing a pharmaceutical composition comprising:
(i) a therapeutic agent; and
(ii) a surfactant;
into the glass container; and
(c) conducting freeze drying.

11. A method for preventing or reducing glass fogging, the method comprising the steps of:
(a) providing a glass container having a contact angle of more than about 10°;
(b) introducing a pharmaceutical composition comprising:
(i) a therapeutic agent; and
(ii) a surfactant;
into the glass container; and
(c) conducting freeze drying.

12. Use of a glass container having a contact angle of more than about 10° for preventing or reducing glass fogging during freeze drying of a pharmaceutical composition comprising:
(i) a therapeutic agent; and
(ii) a surfactant.
